(19) United States
(12) Patent Application Publication
(10) Pub. No.: US 2018/0075128 A1
(43) Pub. Date: Mar. 15, 2018

(54) Identifying Key Terms Related to an Entity

(71) Applicant: Adobe Systems Incorporated, San Jose, CA (US)

(72) Inventors: Balaji Vasan Srinivasan, Bangalore (IN); Anandhavelu Natarajan, Kangeyam (IN)

(73) Assignee: Adobe Systems Incorporated, San Jose, CA (US)

(21) Appl. No.: 15/263,771

(22) Filed: Sep. 13, 2016

(51) Int. Cl. G06F 17/30

(52) U.S. Cl. CPC G06F 17/30598; G06F 17/30864

(57) ABSTRACT

Identifying key terms related to an entity is described. An indication is received of the entity for which the key terms are to be identified. Content posted online about the entity and content about trending topics is collected. Since the trending topic content is collected for being trending, it is initially processed to identify items of trending topic content that are relevant to the entity. Predefined types of terms are extracted from both the posted content about the entity and the trending topic content relevant to the entity. An importance to the entity is determined for the terms extracted from the posted content about the entity and the terms extracted from the trending topic content relevant to the entity using predictive models. The key terms are identified based on importance scores computed for the extracted terms and a relevance of the extracted terms to the entity.

### BACKGROUND

With the increased ubiquity of computing technologies in peoples' daily lives, most companies have developed and maintained an online presence. In many instances, consumers expect to have unfettered access to information about products and services offered by a company. Consumers also expect to be able to access information about the competitors of a company, real-world trends pertinent to the goods and services a company offers, what other people who have used the goods and services think of them, and so forth. As a result, marketers of these companies have the task of providing such information to consumers through a variety of online platforms. Examples of online platforms include a company or brand-specific website, social networking service profiles, podcasts, and the like. Many marketers build online presence using a strategy that is twofold. The strategy involves delivering online promotions for a particular good or service. An example of this is an advertisement for a pair of shoes, such as one that includes an image of the pair of shoes, specifications for the shoes, reasons to buy the shoes, and so on. The strategy also involves continuously engaging customers in a way that not only creates or maintains awareness about the company, but that also increases a perceived value of the company in the minds of customers.

As part of achieving these and other objectives, marketers may collect content from a variety of different sources and share selections of this content via online platforms. Some of the collected content may simply be shared while other selections are repackaged and shared. By way of example, marketers may collect content such as compelling snippets about goods or services of a company, information about unconventional uses of the goods or services, information about tangential topics that customers of the company (or targeted demographic groups) find interesting, information about current trends that are relevant to those customers (or the targeted demographic group), and so on. Due to the sheer volume of content available online and the frequency with which new content is released, however, it can be time-consuming and painstaking for a marketer to try to sift through online content to identify particular selections for sharing.

### SUMMARY

Identifying key terms related to an entity is described. An indication of the entity for which the key terms are to be identified is received. User input indicative of the entity may be received, for instance. Content that is posted online about the entity is collected. The posted content may be collected from social networking services where users can mention the entity in their posts. Content about trending topics is also collected. Trending topic content may be collected from a service that tracks trending topics in online content and maintains a repository of content representative of the trending topics. Since the trending topic content is collected simply for being trending, it is initially processed to identify items of the trending topic content that are relevant to the entity. Predefined types of terms are extracted from both the posted content about the entity and the trending topic content that is relevant to the entity. These predefined types of terms can include named entities, noun phrases, bigrams, and trigrams.

An importance to the entity is determined for the terms extracted from the posted content about the entity and the terms extracted from the trending topic content relevant to the entity. In particular, a first predictive model is built using the extracted posted content terms and key performance indicators (KPIs) for the posted content about the entity. A second predictive model is built using the extracted trending topic terms and trend indicators for the trending topic relevant to the entity. Using these predictive models, importance scores are computed for the extracted terms. The extracted posted content terms and the extracted trending topic terms are then merged into a list that is ranked based on combined importance scores. The terms from this list are then ranked according to their relevance to the entity to form another list of the terms. The key terms are identified by combining the rankings from the two lists.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of a digital medium environment in an example implementation that is operable to employ techniques described herein.

FIG. 2 depicts a system in an example implementation that is configured to identify key terms related to an entity from collected posted content and collected trending topic content.

FIG. 3 depicts an example of a user interface that is generated to present a user with key terms identified for an entity in accordance with one or more implementations.

FIGS. 4A and 4B together are a flow diagram depicting a procedure in an example implementation in which key terms that are related to an entity are identified using content posted online about the entity and content about trending topics.

FIG. 5 is a flow diagram depicting a procedure in another example implementation in which an importance to the entity is computed for terms extracted from content posted online about the entity.

FIG. 6 is a flow diagram depicting a procedure in another example implementation in which an importance to the entity is computed for terms extracted from content about trending topics relevant to the entity.

FIG. 7 illustrates an example system including various components of an example device that can be employed for one or more implementations of techniques for identifying key terms related to an entity that are described herein.

### DETAILED DESCRIPTION

Overview Marketers may collect content to share with customers of a company for a variety of reasons. By way of example, marketers may collect content to implement a marketing strategy that involves continuously engaging customers of the company, such as in an effort to create or maintain awareness about the company (and its goods and services) or to increase a perceived value of the company in the minds of the customers. Due to the sheer volume of content available online and the frequency with which new content is released, however, it can be time-consuming and painstaking for a marketer to try to sift through online content to identify particular selections for sharing.

The act of searching through content and identifying particular selections for sharing may be referred to herein as “curating”. Although a marketer may offload this burden by hiring someone else to perform the curating (e.g., a consultancy service having experts that provide curated content to marketers), doing so may still be time-consuming for the person or people eventually responsible for the curation. Clearly, this merely shifts the burden associated with content curation from one party to another. Further, some conventional techniques simply use keywords provided by a marketer to search repositories for content that includes those keywords or semantically-related terms. However, these techniques may not uncover content beyond what a marketer identifies using such keywords. Accordingly, conventional techniques for searching for content related to an entity and identifying selections for sharing may be time-consuming and may be limited to searching using keywords.

Identifying key terms related to an entity by a computing device is described. In contrast to conventional techniques, the disclosed techniques involve a computing device configured to provide a user (e.g., a marketer) with key terms for an entity, where these key terms are taken from content representing an intersection of interest in the entity, current trends, and interests of a community associated with the entity.

The techniques involve a computing device receiving, from remote servers such as social networking servers, content posted only about the entity by users to identify key terms related to an entity. The techniques also involve the computing device receiving, from remote servers such as content repository servers, content about trending topics to identify the key terms. Further, the computing device determines interests of a community associated with the entity to identify the key terms. The content posted about the entity by users may refer to historical posts about the entity, such as posts that are made by users of social networking services (e.g., Facebook®, Twitter®, YouTube®, Instagram®, Hyperlapse®, and so forth) and mention the entity.

In one or more implementations, a computing device collects historic content posted about the entity to identify the key terms. From these collected posts, the computing device extracts named entities, noun phrases, bigrams, and trigrams. The computing device utilizes a predictive model, such as a Random Forest model, to predict a relative importance of these extracted terms to the entity—the relative importance allows the terms to be ranked.

As noted above, the computing device also collects content about trending topics. For instance, the computing device may collect this content from a service that provides a repository of content about trending topics, e.g., the service tracks mentions of topics, selects content that is representative of topics (e.g., articles) determined to be trending, and maintains a list of selections in the repository that reflect currently trending topics. For each collected piece of trending topic content, the computing device computes a respective relevance to the entity. Using the computed relevance, the computing device determines the most relevant trending topic content. The computing device then processes the trending topic content, like the historical posts, to extract named entities, noun phrases, bigrams, and trigrams. The computing device then uses the extracted terms as input to a predictive model to capture a relative importance of these extracted terms to the entity—allowing these terms to also be ranked.

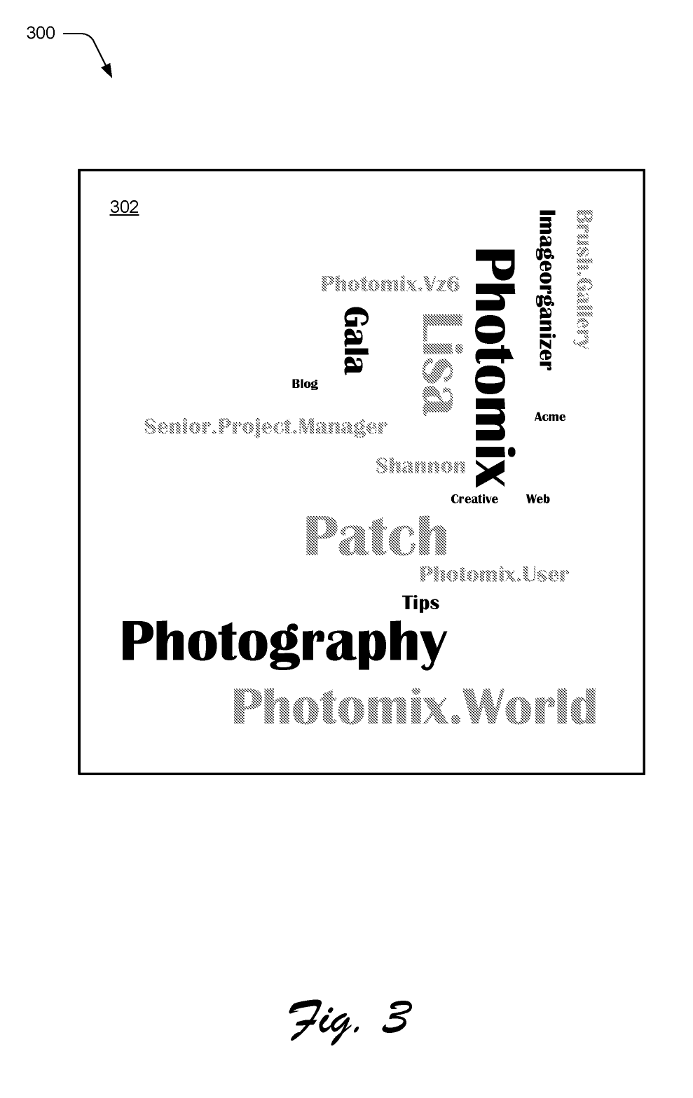

A computing device may then merge the ranked terms from the historical posts and from the trending topic content. The merged set of terms corresponds to the key terms. The computing device may also rank the key terms, and may present the key terms to a user in any of a variety of different ways. For example, the computing device may present the key terms in an ordered list (e.g., in order of determined relative importance to the entity), in an arrangement of the key terms that visually indicates a relative importance as further described in reference to FIG. 3, and so on. In an example where the user is a marketer and the entity is a brand, the techniques described herein can present the marketer with key terms for the brand. The marketer may then leverage these key terms for identifying content to share with brand customers, developing content to share with the brand customers, and the like. The key terms presented in accordance with the techniques described herein can aid marketers in delivering content that is more effective at achieving a performance objective (e.g., conversion to buy a branded product, continue or increase interaction with channels of the brand, perceive a greater value of the brand or a branded product, etc.) than conventional techniques.

### Term Descriptions

As used herein, an “entity,” for which the key terms are identified, refers to a person, place, organization, business name (e.g., a doing-business-as (DBA) name), identifier of a good or service, and so on. In other words, the “entity” corresponds to a primary term or terms for which other related terms (e.g., the key terms) are identified. By way of example, an “entity” may correspond to a brand, such as a name of a company that produces software, athletic apparel, and so forth. In some instances, an “entity” may be used herein to refer to proper nouns extracted from content. However, when “entity” refers to a term that is extracted from content (e.g., not the term for which the key terms are identified), it will be used in conjunction with the term “named” so as to form the term “named entity” or “named entities.”

As used herein, “key terms” refer to a word or set of words that not only relate to an entity, but also that have been identified in the manner described below from among merely related words.

As used herein, a “trending topic” refers to a topic that is generally popular in online content and other media. Computing devices may determine trending topics in a variety of known ways, such as based on a number of mentions by online content sources, a number of mentions by online users, and so forth. In other words, trending topics are mentioned more over the course of some time period than other topics—trending topics may be the most-mentioned topics.

As used herein, “interests” of a community associated with an entity may correspond to interests of customers of the entity, a demographic group that has been identified in association with the entity, users having user profiles in association with the entity, users that “like” a social networking page of the entity, users that signed up to receive emails from the entity, and so forth. In any case, the “community” refers to a group of users or people associated in some manner with the entity.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

### Example Environment

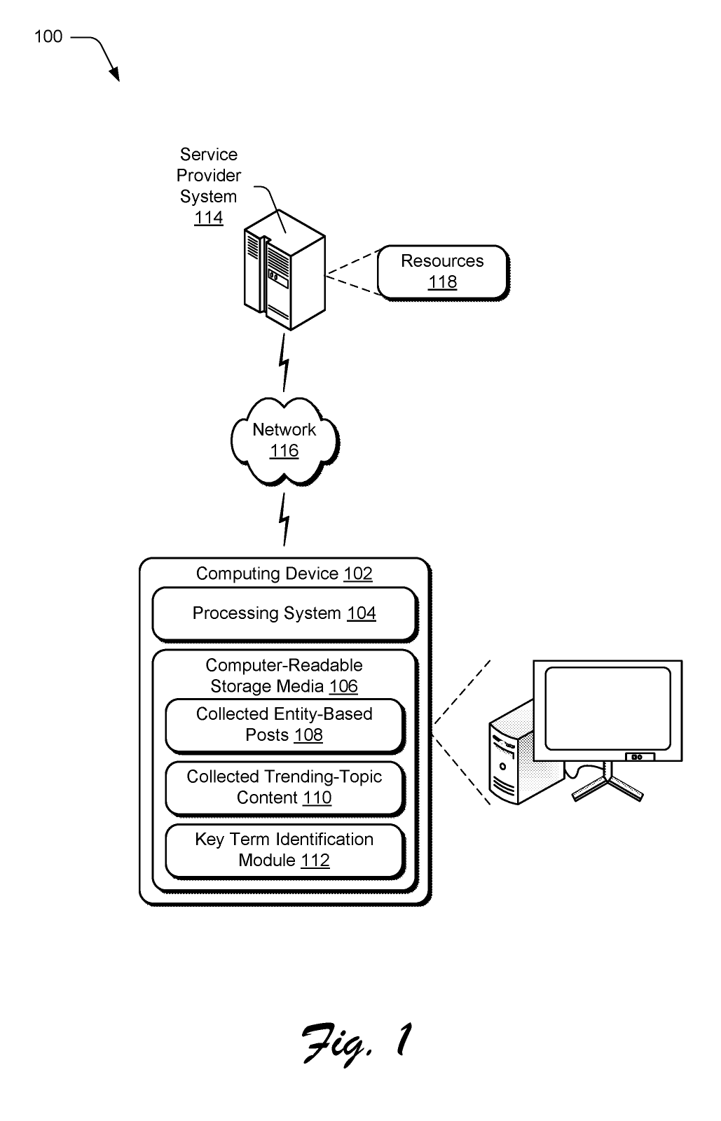

FIG. 1 is an illustration of an environment 100 in an example implementation that is operable to employ techniques described herein for identifying key terms related to an entity. The illustrated environment 100 includes a computing device 102 having a processing system 104 that includes one or more processing devices (e.g., processors) and one or more computer-readable storage media 106. The illustrated environment 100 also includes collected entity-based posts 108, collected trending-topic content 110, and key term identification module 112, which are embodied on the computer-readable storage media 106 and operable via the processing system 104 to implement corresponding functionality described herein. In at least some implementations, the computing device 102 includes functionality to access various kinds of web-based resources (content and services), interact with online providers, and so forth as described in further detail below.

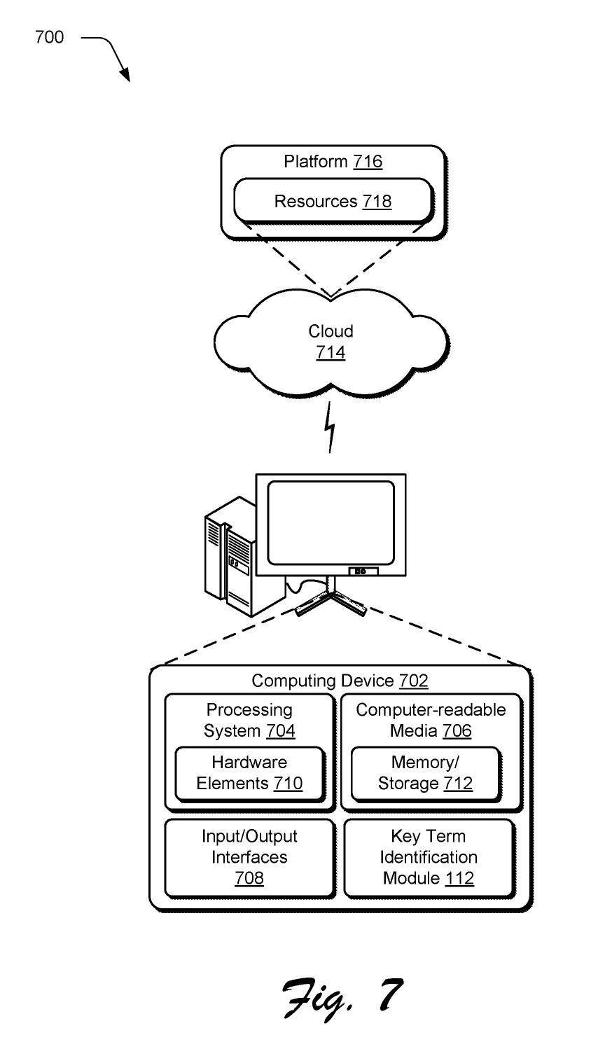

The computing device 102 is configurable as any suitable type of computing device. For example, the computing device 102 may be configured as a server, a desktop computer, a laptop computer, a mobile device (e.g., assuming a handheld configuration such as a tablet or mobile phone), a tablet, a device configured to receive gesture input, a device configured to receive three-dimensional (3D) gestures as input, a device configured to receive speech input, a device configured to receive stylus-based input, a device configured to receive a combination of those inputs, and so forth. Thus, the computing device 102 may range from full resource devices with substantial memory and processor resources (e.g., servers, personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 7.

The environment 100 further depicts one or more service provider systems 114, configured to communicate with the computing device 102 over a network 116, such as the Internet, to provide a “cloud-based” computing environment. Generally speaking, service provider systems 114 are configured to make various resources 118 available over the network 116 to clients. In some scenarios, users sign up for accounts that are employed to access corresponding resources from a provider. The provider authenticates credentials of a user (e.g., username and password) before granting access to an account and corresponding resources 118. Other resources 118 are made freely available, (e.g., without authentication or account-based access). The resources 118 can include any suitable combination of services and/or content typically made available over a network by one or more providers. Some examples of services include, but are not limited to, social networking services (e.g., Facebook®, Twitter®, Instagram®, Hyperlapse®, and the like), news services that deliver news stories via a variety of digital mediums, digital content repository services capable of collecting digital content for indexing and storage, search engine services capable of returning search results, and so forth.

Service providers serve as sources of significant amounts of content. The collected entity-based posts 108 and the collected trending-topic content 110 represent a fraction of content that may be accessible to a user of the computing device 102. The collected entity-based posts 108 and the collected trending-topic content 110 may be configured to include a variety of different content that may be stored at the computing device 102 or accessible at least temporarily to the computing device 102. By way of example and not limitation, the collected entity-based posts 108 and the collected trending-topic content 110 can include various combinations of text, images, videos, vector graphics, audio clips, and so on.

Regardless of the particular types of content included in the collected entity-based posts 108 and the collected trending-topic content 110, the included content may be formatted in any of a variety of different digital formats. When the included content corresponds to an image, for instance, the image can be formatted in formats including but not limited to JPEG, TIFF, RAW, GIF, BMP, PNG, and so on. Indeed, the collected entity-based posts 108 and the collected trending-topic content 110 may represent a variety of types of content and combinations of those types without departing from the spirit or scope of the techniques described herein.

The key term identification module 112 represents functionality to implement aspects of identifying key terms related to an entity as described herein. Initially, an entity for which related key terms are to be identified is obtained. Consider an example in which the entity is a brand that identifies a company and one or more of its products. In this example, a user of the computing device 102 may correspond to a marketer for the brand. Accordingly, an indication of the entity may be obtained from the marketer via user input. For instance, the marketer may enter the brand via a user interface presented by the computing device 102, e.g., the marketer may type in, speak, or otherwise provide input indicating a brand name. In one or more implementations, the user may also enter a number of keywords the user believes describe the brand, describe a market the brand serves, or otherwise relate to the brand. In some scenarios, a marketer may be in charge of multiple brands and may input those brands and keywords once to the system. In these scenarios, the brands may be saved so that in the future the user can initiate key term identification by simply selecting an option to do so, e.g., an option that indicates key terms will be identified for a given brand responsive to selection of the option.

Regardless of when or how the entity is indicated, the key term identification module 112 may initiate identification of the key terms for the entity by collecting content. In particular, the key term identification module 112 represents functionality to collect historic posts about the entity and content about trending topics. As noted above, the collected entity-based posts 108 and the collected trending-topic content 110 represent this information. The collected entity-based posts 108 represent, at least in part, posts made by users about the entity. The collected entity-based posts 108 may be collected by searching predetermined social network services for the entity and scraping the posts from the social network service that mention the entity. For example, the posts may be published by a user via one or more social networking services and include content (e.g., an image, video, or hyperlink), indications of people who like or dislike the post (or other reactions to the post), comments about the post, shares of the post, and so forth. Reactions to a post can also be captured by analyzing a sentiment toward the brand in user comments and the like.

In contrast, the collected trending-topic content 110 represents, at least in part, content (e.g., articles) that is about trending topics and which may be collected from a repository, e.g., Bitly®. As discussed above, trending topics in online content may be determined in a variety of known ways. Further, some of the collected trending-topic content 110 may not be relevant to the entity—it may be collected simply because one or more topics the content (e.g., article) is about are trending at the time of collection.

The key term identification module 112 processes the collected entity-based posts 108 and the collected trending-topic content 110 to generate digital content identifying the key terms related to the entity. Since the collected entity-based posts 108 are already known to be about the entity—the posts are collected because they mention entity or are determined to be about the entity in another way—the key term identification module 112 may not determine a relevance of these posts to the entity. Instead, the key term identification module 112 may simply extract from each of the collected entity-based posts 108 the named entities, noun phrases, bigrams, and trigrams. These extracted terms are then used, along with other sentiment information collected from the posts, to build a predictive model that indicates an importance of an extracted term to the entity.

As mentioned above, some of the collected trending-topic content 110 may be unrelated to the entity. As such, the key term identification module 112 initially processes the collected trending-topic content 110 to determine a relevance of each item of the collected trending-topic content 110 to the entity. A subset of the collected trending-topic content 110 that is determined to be relevant to the entity is then further processed. This subset may be formed by taking the top N content items (where N is a predetermined static number, a predetermined number based on a number of items found, etc.), taking the content items that have a relevance score above a relevance threshold, and so forth. The key term identification module 112 then further processes the relevant collected trending-topic content 110 by extracting the named entities, noun phrases, bigrams, and trigrams. These extracted items are then used, along with other information indicative of the trending (e.g., numbers of views, clicks, shares, etc.), to build another predictive model that indicates an importance of these extracted terms to the entity.

The output of each predictive model is a list of tuples that each include one of the extracted terms and a respective importance score. Further, the importance scores are normalized so a relative importance of the terms in each list can be determined. Based on the importance scores, the key term identification module 112 merges the two lists of terms according to a combining function. Once the lists are combined, the key term identification module 112 determines a relevance of the listed terms to the entity. The terms of this final list, are the identified key terms.

In one or more implementations, a user may set a number of key terms, the number of key terms may be based on a number of terms in the merged list that have a relevance score greater than some threshold or based on a number of terms in the two lists that have an importance score above some threshold, and so forth. Once the key terms are identified, the key term identification module 112 can present them to a user. For example, the key term identification module 112 can present them in a ranked list, present them in an arrangement that visually indicates their ranking as depicted in FIG. 3, or present them in a variety of other ways without departing from the spirit or scope of the techniques described herein.

In one or more implementations, the key term identification module 112 is implementable as a software module, a hardware device, or using a combination of software, hardware, firmware, fixed logic circuitry, etc. Further, the key term identification module 112 can be implementable as a standalone component of the computing device 102 as illustrated. In addition or alternatively, the key term identification module 112 can be configured as a component of a web service, an application, an operating system of the computing device 102, a plug-in module, or other device application as further described in relation to FIG. 7.

Having considered an example environment, consider now a discussion of some example details of the techniques for identifying key terms related to an entity in accordance with one or more implementations.

Identifying Key Terms Related to an Entity

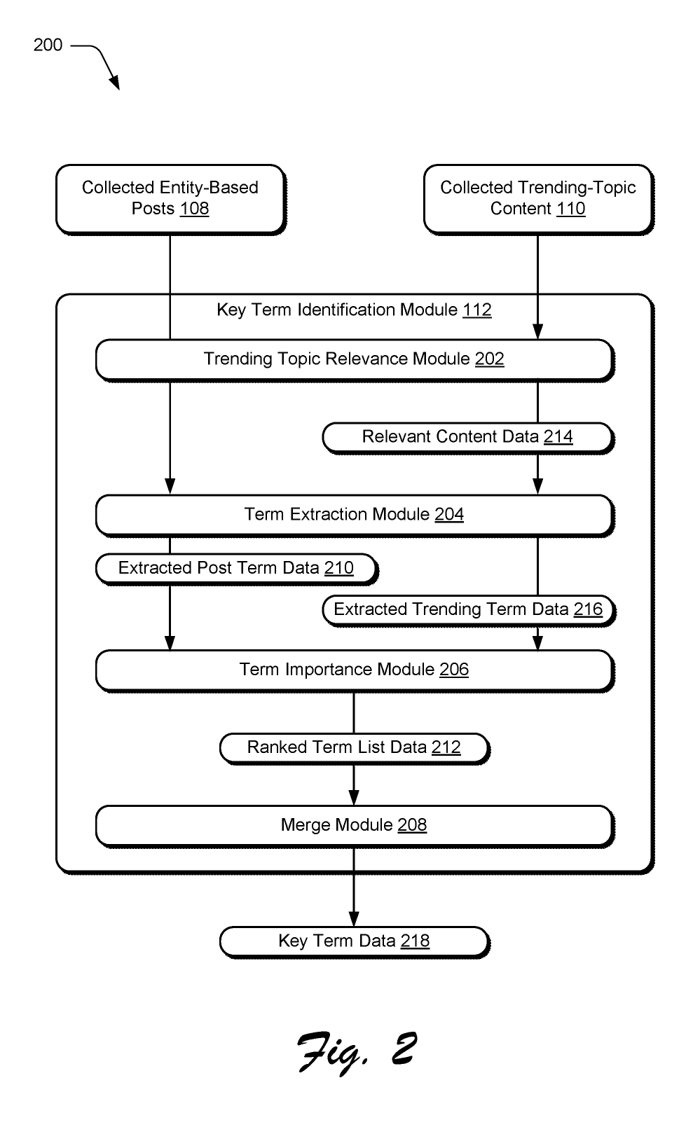

This section describes some example details of techniques for identifying key terms related to an entity in accordance with one or more implementations. FIG. 2 depicts a system 200 that can be implemented in the digital environment of FIG. 1 for identifying key terms related to an entity from collected posted content and collected trending topic content.

The example system 200 includes the collected entity-based posts 108, the collected trending-topic content 110, and the key term identification module 112 of FIG. 1, which takes as input the collected entity-based posts 108 and the collected trending-topic content 110. In one or more implementations, the key term identification module 112 may be configured to initiate collection of the entity-based posts and the trending-topic content. Thus, although not illustrated, the key term identification module 112 may take as input an indication of the entity, e.g., a typed word or words corresponding to the entity. The key term identification module 112 may also take a number of keywords that relate to the entity as input (also not shown). By way of example, the key term identification module 112 may receive user input indicative of the entity and the keywords via a user interface. Given these, the key term identification module 112 can initiate collection of the entity-based posts and the trending-topic content.

In any case, the key term identification module 112 uses the collected entity-based posts 108 and the collected trending-topic content 110 to identify key terms for the entity. The key term identification module 112 is illustrated with multiple different modules representative of its functionality, including trending topic relevance module 202, term extraction module 204, term importance module 206, and merge module 208. These different modules are included in the example system 200 for the purpose of discussion. In implementation, the key term identification module 112 may not include such modules to carry out the functionality described. Rather, the key term identification module 112 may include fewer or more modules to carry out the described functionality, or may include different modules to carry out the described functionality.

In general, the term extraction module 204 represents functionality of the key term identification module 112 to extract named entities, noun phrases, bigrams, and trigrams from content. In the illustrated example, the collected entity-based posts 108 are depicted being input to the term extraction module 204. Thus, the term extraction module 204 processes the collected entity-based posts 108 to extract the named entities, noun phrases, bigrams, and trigrams found in those posts. Extracted post term data 210 (extracted terms 210) represents the named entities, noun phrases, bigrams, and trigrams the term extraction module 204 extracts from the collected entity-based posts 108. To extract these, the term extraction module 204 may parse data structures corresponding to the collected entity-based posts 108, identify text portions of the collected entity-based posts 108 based on the parsing, check the text portions for named entities, noun phrases, bigrams, and trigrams, and generate a list of those terms found in the text portions.

The key term identification module 112 also represents functionality to track key performance indicators (KPIs) of the collected entity-based posts 108. The reaction of a user to posted content may reflect a sentiment of the user toward the post. For example, the act of a user to like (or dislike) or share a post, in connection with comments made by the user about the post, may reflect whether the user has positive or negative sentimentality toward the post. The reaction of the user may also indicate a degree to which the user feels positively or negatively about the post.

KPIs correspond to any of a variety of different actions taken by users relative to posts that can be tracked, and can indicate a performance of the posts in achieving an action. By way of example, KPIs for online posts may correspond to likes, dislikes, shares, views, an average amount of time viewed, a number of comments, a number of comments expressing positive sentimentality toward a post (or another comment made about the post), a number of comments expressing negative sentimentality toward the post (or another comment made about the post), reposts, hyperlinks that reference the post, an influence of users interacting with the post, and so forth. The KPIs may be determined by parsing information associated with a post (such as metadata) that describes the KPIs (e.g., information indicating a number of likes) or can be analyzed to derive the KPIs (e.g., comments can analyzed to determine a positive sentimentality toward the post). KPIs may be determined in other ways without departing from the spirit or scope of the techniques herein.

In one or more implementations, computations for determining which of the extracted terms are important involve a KPI of interest. The KPI of interest may be selected by a user, based on a social networking service corresponding to a post, determined by the key term identification module 112 (or the modules thereof), and so forth. A KPI of interest or KPIs of interest may be selected in a variety of different ways without departing from the spirit or scope of the techniques describe herein.

The term importance module 206 represents functionality of the key term identification module 112 to determine an importance of the extracted post terms 210 to the entity. In particular, the term importance module 206 determines how predictive the extracted post terms 210 are for a KPI of interest. Consider an example in which the entity corresponds to a brand associated with a software developer (e.g., Software Dev, Inc.), the software developer has an image editing application (e.g., called Photomix), and one of the extracted post terms 210 is “photography”. Assume in this example, that the collected entity-based posts 108 include information describing how many users like those posts and that the KPI of interest is post likes. Given this, the term importance module 206 may determine how predictive inclusion of the word “photography” is for obtaining a like or a number of likes, e.g., 100 likes. If, relative to the other extracted post terms 210, use of the word “photography” is more predictive of a post having a like (or having the number of likes) than the other terms, then “photography” may be considered “more important” than those other terms. Accordingly, if use of the word “photography” is less predictive of a post having a like (or the number of likes) than the other terms, then “photography” may be considered “less important” than those terms.

To determine an importance of the extracted post terms 210, the term importance module 206 may initially compute the term frequency-inverse document frequency (TFIDF) for each of the extracted post terms 210. Broadly speaking, TFIDF is a numerical statistic that reflects how important a word is to a document in a collection of documents or corpus. Here, the term importance module 206 computes the TFIDF for the extracted post terms 210. Thus, the computed TFIDF of an extracted post term reflects its importance to a corresponding post given the collected entity-based posts 108. Although use of TFIDF is described herein, the term importance module 206 may utilize other techniques for determining how important a given term is to a corresponding post given the collected entity-based posts 108. The term importance module 206 is thus configured to compute a statistic indicative of this importance for each of the extracted post terms 210.

With this information, the term importance module 206 builds a predictive model between the extracted post terms 210 and the KPI of interest (e.g., likes, comments having positive sentiment, shares, views, etc.) as the output vector of the predictive model. The output vectors of this predictive model indicate the feature importance of the extracted post terms 210 to the KPI of interest, e.g., how predictive inclusion of the extracted post terms 210 is of achieving an action. The term importance module 206 also scores the importance of each of the extracted post terms 210 as a feature for the predictive model, e.g., the term importance module 206 computes the importance of each TFIDF dimension to the predictive model. The term importance module 206 may build any of a variety of different types of predictive models without departing from the spirit or scope of the techniques described herein. By way of example, the predictive model may be a Random forest model, a neural network, a classification and regression tree (CART), and so forth.

Using the predictive model, the term importance module 206 is capable of determining a normalized importance score for each of the extracted post terms 210. For instance, the term importance module 206, through building the model, is capable of generating a list of tuples (one tuple for each of the extracted post terms 210). These tuples indicate the normalized importance score of each of the extracted post terms 210. In one or more implementations, each tuple comprises a pair of values, such that one of the values identifies the term and the other indicates the determined importance. The value identifying the term may be configured as a string type, e.g., capable of indicating the term “Photomix,” the bigram “Photomix.user,” etc. The value indicating the importance may be configured as a floating point type, e.g., capable of indicating normalized values between 0 and 1.

The term importance module 206 is further configured to rank the extracted post terms 210 based on respective importance scores. The term importance module 206 captures the ranking of these terms by generating a ranked list, e.g., a list in which the extracted post terms 210 are ordered according to respective importance scores. The ranked list formed from the extracted post terms 210 is one of the lists represented by ranked term list data 212 (ranked term lists (212). The ranked term lists 212 also include a ranked list having terms from the collected trending-topic content 110 as discussed below.

As mentioned above, the collected trending-topic content 110 represents, at least in part, content (e.g., articles) about trending topics. As further mentioned above, the collected trending-topic content 110 may be collected from a repository capable of maintaining information about trending topics and the corresponding content, e.g., Bitly®, TinyURL®, and so forth. While the collected trending-topic content 110 is about trending topics, some of the collected trending-topic content 110 may be unrelated to the entity. To improve the efficiency of the techniques herein and ensure that the ranked term lists 212 include terms from content that is actually relevant to the entity, the key term identification module 112 may remove some of the collected trending-topic content 110 from consideration.

To remove some content from consideration, the key term identification module 112 may employ the trending topic relevance module 202. The trending topic relevance module 202 represents functionality to determine a relevance of an item of the collected trending-topic content 110 to the entity. For each item of the collected trending-topic content 110, the trending topic relevance module 202 computes a respective relevance score. The respective relevance scores are normalized so that items of the collected trending-topic content 110 can be compared and ranked according to the scores. In this way, the trending topic relevance module 202 can determine whether a content item is “more” or “less” relevant to the entity than other content items.

Relevant content data 214 (relevant content 214) represents the items of the collected trending-topic content 110 that the trending topic relevance module 202 determines are relevant to the entity. The relevant content 214 may correspond to a subset of items of the collected trending-topic content 110. The relevant content 214 may be the top N content items (where N is a predetermined static number, a predetermined number based on number of items found, etc.) in terms of relevance scores, the content items having a relevance score above a relevance threshold, and so forth.

In one or more implementations, the trending topic relevance module 202 determines a relevance of the collected trending-topic content 110 to the entity by initially identifying a group of representative terms relevant to the entity. The trending topic relevance module 202 may determine these representative terms through semantic queries. The semantic queries may query for relationships and properties associated with a variety of known resources. By way of example, the trending topic relevance module 202 determines representative terms that relate to the entity using a standard taxonomy, such as DBpedia®. The trending topic relevance module 202 then determines similarities of each item of the collected trending-topic content 110 to the representative terms associated with the entity. A variety of different techniques for determining similarity between a given content item and representative terms may be used in the spirit and scope of the techniques described herein. By way of example, the trending topic relevance module 202 may compute similarity metrics like aggregated relevance for each item of the collected trending-topic content 110 to each of the representative terms. Regardless of how the trending topic relevance module 202 determines a relevance score, the trending topic relevance module 202 identifies the relevant content 214 from the collected trending-topic content 110.

In the illustrated example, the relevant content 214 is depicted being input to the term extraction module 204. Thus, the term extraction module 204 processes the relevant content 214 to extract the named entities, noun phrases, bigrams, and trigrams found therein. Extracted trending term data 216 (extracted trending terms 216) represent the named entities, noun phrases, bigrams, and trigrams the term extraction module 204 extracts from the relevant content 214. To extract these, the term extraction module 204 may check text portions of the relevant content 214 for named entities, noun phrases, bigrams, and trigrams, and generate a list of those terms found in the text portions.

In addition to the functionality already described, the key term identification module 112 also represents functionality to track trend indicators of the collected trending-topic content 110. By way of example, trend indicators of online content may correspond to clicks on the content, views of the content, shares of the content, and so on. The key term identification module 112 may collect values for the trend indicators from metadata associated with the collected trending-topic content 110. In one or more implementations, computations for determining which of the extracted trending terms 216 are important involve these trend indicators.

In addition to determining an importance of the extracted post terms 210, the term importance module 206 also represents functionality of the key term identification module 112 to determine an importance to the entity of the extracted trending terms 216. In particular, the term importance module 206 determines how predictive the extracted post terms 210 are of the trend indicators. Consider again the example in which the entity corresponds to a brand associated with a software developer (e.g., Software Dev, Inc.) and the software developer has an image editing application (e.g., called Photomix). Assume in this example that one of the extracted trending terms 216 is “photography”. Given this, the term importance module 206 may determine how predictive inclusion of the word “photography” is for indicating trendiness (according to the trend indicators) of an item of the relevant content 214. In general, larger values for trend indicators (e.g., more clicks, views, shares) indicate that a content item is more trendy.

If, relative to the other extracted trending terms 216, use of the word “photography” is more predictive of larger numbers of trend indicators than the other terms, then “photography” may be considered “more important” than those other terms. Accordingly, if use of the word “photography” is less predictive of a content item having larger numbers of trend indicators than the other terms, then “photography” may be considered “less important” than those other terms.

To determine an importance of the extracted trending terms 216, the term importance module 206 may build another predictive model. In particular, the term importance model builds a predictive model between the extracted trending terms 216 and the trend indicators as the output vector of this second predictive model. The output vectors of the second predictive model indicate the feature importance of the extracted trending terms 216 to the trend indicators, e.g., how predictive inclusion of the extracted trending terms 216 is of trending. This second predictive model may be of the same type or a different type than the predictive model built between the extracted post terms 210 and the KPI of interest. In building this second model, the term importance module 206 scores the importance of each of the extracted trending terms 216 as a feature of the predictive model, e.g., the term importance module 206 may compute an importance of TFIDF dimensions to this predictive model.

Using this second predictive model, the term importance module 206 determines a normalized importance score for each of the extracted trending terms 216. By way of example, the term importance module 206, through building this second model, is capable of generating another list of tuples (one tuple for each of the extracted trending terms 216). The tuples of this second list indicate the normalized importance score of each of the extracted trending terms 216. In one or more implementations, each tuple comprises a pair of values, such that one of the values identifies the term and the other indicates the determined importance. The values identifying the term and indicating the importance may be configured in a same manner as described above.

Like with the extracted post terms 210, the term importance module 206 is configured to rank the extracted trending terms 216 based on respective importance scores. The term importance module 206 captures the ranking of these terms by generating another ranked list, e.g., a list in which the extracted trending terms 216 are ordered according to respective importance scores. This second ranked list, formed from the extracted trending terms 216, is also one of the lists represented by the ranked term lists 212.

The merge module 208 represents functionality of the key term identification module 112 to merge the ranked term lists 212. In particular, the merge module merges the ranked list generated from the extracted post terms 210 with the ranked list generated from the extracted trending terms 216. The merge module 208 may merge the lists by combining the importance scores of the terms. For example, the merge module 208 may use a monotonic function ƒ( ) to combine the scores of the ranked term lists 212, e.g., the ranked list generated from the extracted post terms 210 and the ranked list generated from the extracted trending terms 216. In one or more implementations, the function ƒ( ) is a simple average. Combining these scores as discussed may be effective to ensure that the eventual ranking of key terms represented by the key term data 218 (key terms 218) reflects the interest of the community associated with the entity. Such combining may also be effective to ensure that the eventual ranking of the key terms 218 reflects current trends observed in online content.

The result of combining the ranked term lists 212 is a single list of terms ranked based on the combined scores (not shown). The terms of this single list are ranked according to the combined scores. The merge module 208 further processes this list and the terms thereon to identify the key terms 218. In particular, the merge module 208 computes a relevance to the entity for each of the terms in the single list. The merge module 208 may compute the relevance of these terms in a similar manner as the trending topic relevance module 202 determines a relevance to the entity of the collected trending-topic content 110.

To compute the relevance, the merge module 208 may initially identify a group of representative terms that are relevant to the entity. For example, the merge module 208 may use the representative terms identified by the trending topic relevance module 202. The merge module 208 may then determine similarities of each term in the combined list of terms to the representative terms. The merge module 208 may, for instance, compute similarity scores for the terms in the combined list. Rather than determine relevance scores in this way, the merge module 208 may use co-occurrences of the terms in content posted online to one or more social networking services. The merge module 208 may determine relevance scores for the terms in the combined list in a variety of ways without departing from the spirit or scope of the techniques described herein.

Regardless of how these relevance scores are determined, the merge module 208 re-ranks the terms of this combined list according to relevance scores. The key term identification module 112 thus generates four different lists of ranked terms. These lists include (1) a first list of ranked terms generated from the extracted post terms 210, (2) a second list of ranked terms generated from the extracted trending terms 216, (3) a third list of ranked terms that is formed by merging the terms of the first and second lists and in which the terms are ranked based on combined scores, and (4) a fourth list of ranked terms comprising the terms from the third list but having those terms ordered based on relevance scores indicative of relevance to the entity.

Based on one or more of those lists, the merge module 208 is configured to compute a fifth list indicating the key terms 218. To compute the fifth list, for instance, the merge module 208 may merge the scores of the third and fourth lists via merge aggregation. The manner in which the merge module 208 computes the fifth list is configured to move terms that are irrelevant to the entity to less favorable positions of that list, e.g., less favorable rankings. The manner in which the merge module 208 computes the fifth list is also configured to move terms that are relevant to the entity but perform poorly historically in posted content to less favorable positions of the list. The key terms 218 thus represent a list of terms ranked so that the terms that are both relevant to the entity and perform well historically in posted content (e.g., according to one or more KPIs) are ranked favorably, and so that terms having deficiencies in either of those aspects are ranked less favorably.

Additionally, the key terms 218 are presented to a user in a manner that conveys a ranking. For instance, the key terms 218 may simply be presented in a list in an order that corresponds to the ranking, e.g., the fifth list described above may be presented to a user in the ranked order. The key terms 218 may also be presented in other ways that visually indicate the ranking of the terms relative to other terms. As an example, consider FIG. 3.

FIG. 3 depicts an example at 300 of a user interface that is generated to present a user with key terms identified for an entity. In particular, user interface 302 includes multiple different terms presented with different sized fonts. For instance, the terms “Photography,” “Patch,” “Photomix.World,” “Photomix,” and “Lisa” have larger fonts than the other terms. The user interface 302 may represent a scenario in which each of the key terms identified for an entity are presented. However, the terms “Photography,” “Patch,” “Photomix.World,” “Photomix,” and “Lisa” may be more favorably ranked than the other key terms. Accordingly, these terms are presented in a manner that causes them to stand out visually more than the other key terms. The terms “Blog,” “Acme,” “Creative,” and “Web” have smaller fonts than the other items—these terms therefore may not stand out as much visually in the user interface 302 as the other terms. The terms “Blog,” “Acme,” “Creative,” and “Web” may be presented with smaller font because they are less favorably ranked than the other key terms. Although larger and smaller fonts are used to emphasize and deemphasize terms to indicate a ranking among the key terms, the key terms may be presented in other ways that visually emphasize or deemphasize them to indicate a ranking.

The user interface 302 may also convey other information about the key terms. For instance, the user interface 302 may visually convey whether a key term originates from one of the collected entity-based posts 108 or from an item of the collected trending-topic content 110. In the user interface 302, the terms “Photomix,” “Photography,” “Gala,” “Imageorganizer,” “Tips,” “Blog,” “Acme,” “Creative,” and “Web” are presented in a darker shade than the terms “Photomix.World,” “Patch,” “Lisa,” “Photomix.User,” “Shannon,” “Senior.Project.Manager,” “Photomix.Vz6,” and “Brush.Gallery.” This can indicate that the darker shaded terms originate from the collected entity-based posts 108 while the terms with the lighter shading originate from the collected trending-topic content 110. Alternately, presentation in the depicted manner can indicate that the darker shaded terms originate from the collected trending-topic content 110 while the terms with the lighter shading originate from the collected entity-based posts 108. The user interface 302 may present the key terms in ways that visually convey a variety of other information.

Having discussed example details of the techniques for identifying key terms related to an entity, consider now some example procedures to illustrate additional aspects of the techniques.

### Example Procedures

This section describes example procedures for identifying key terms related to an entity in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a suitably configured device, such as the example computing device 102 of FIG. 1 that makes use of a key term identification module 112 or one implemented as the example system 200 of FIG. 2, which also make use of that module.

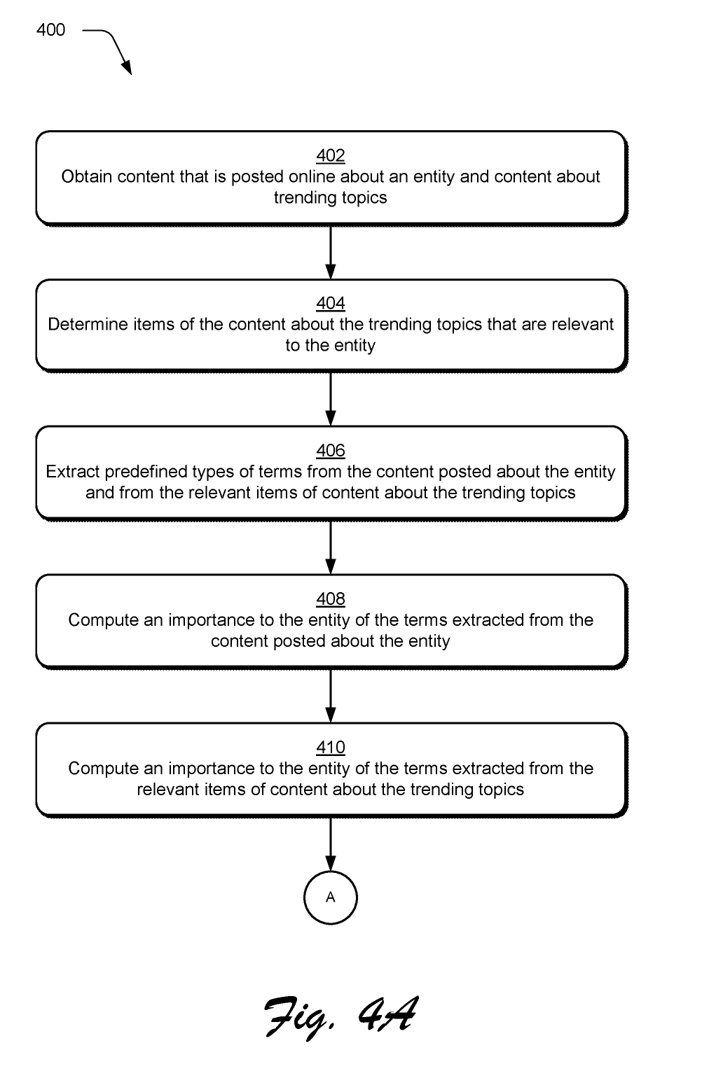

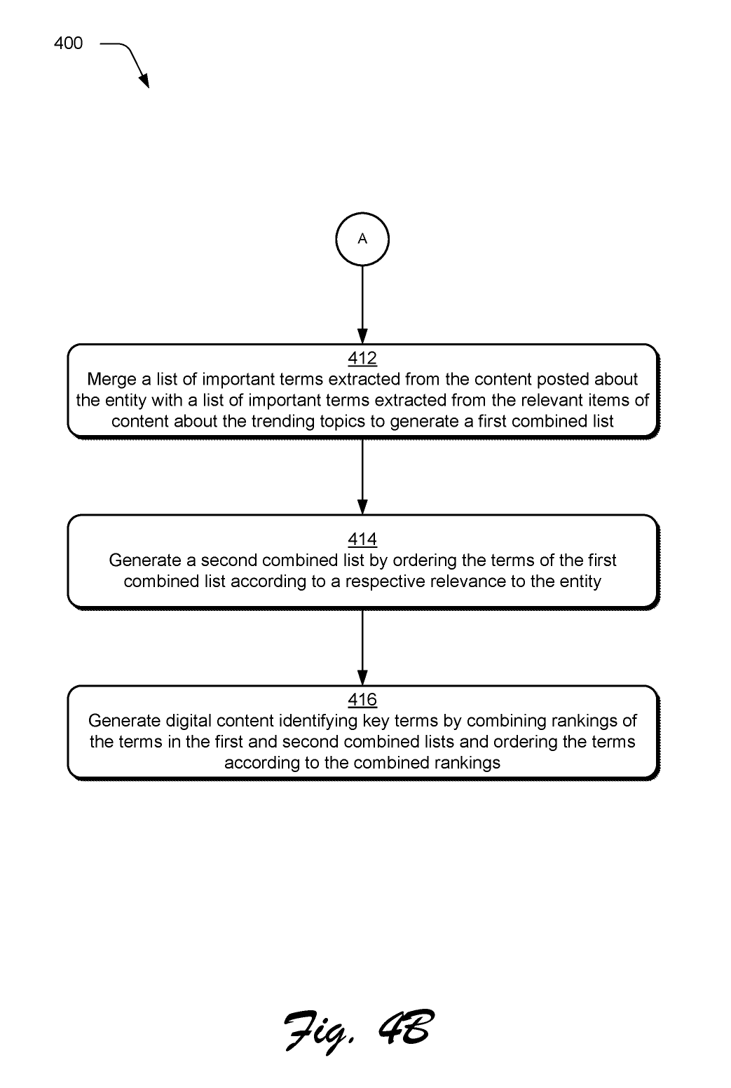

FIGS. 4A and 4B depict an example procedure 400 in which key terms that are related to an entity are identified using content posted online about the entity and content about trending topics. Content that is posted online about an entity and content about trending topics is obtained (block 402).

For example, the key term identification module 112 collects information corresponding to posts from one or more social networking services. These posts mention the entity or keywords associated with the entity, an indication of which may have been received from user input to initiate identification of the key terms for the entity. The key term identification module 112 also collects information corresponding to content about trending topics. As discussed above, the key term identification module 112 may collect this information from a service configured to track trending topics and maintain a repository of content corresponding to the trending topics.

A determination is made as to which items of content about the trending topics are relevant to the entity (block 404). For example, the trending topic relevance module 202 determines which items of the collected trending topic content 110 are relevant to the entity. The trending topic relevance module 202 may do so in the manner described in more detail above.

Predefined types of terms are extracted from the content posted online about the entity and from the relevant items of trending topic content (block 406). For example, the term extraction module 204 processes the collected entity-based posts 108 to extract the named entities, noun phrases, bigrams, and trigrams from those posts, thereby deriving the extracted post terms 210. The term extraction module 204 also processes the relevant content 214 to extract the named entities, noun phrases, bigrams, and trigrams from those items of content. From this, the term extraction module 204 derives the extracted trending terms 216.

An importance to the entity is computed for the terms extracted from the content posted online about the entity (block 408). For example, the term importance module 206 computes an importance to the entity of the extracted post terms 210 by building a predictive model based on the extracted post terms 210. In particular, the term importance module 206 computes an importance score for each of the extracted post terms 210. The term importance module 206 generates a list of the extracted post terms 210 ordered according to the respective importance scores. The importance scores are normalized so that the extracted post terms 210 can be compared and ranked using the importance scores.

An importance to the entity is computed for the terms extracted from the relevant items of content about the trending topics (block 410). For example, the term importance module 206 computes an importance to the entity of the extracted trending terms 216 by building another predictive model. This predictive model, however, is built based on the extracted trending terms 216. In particular, the term importance module 206 computes an importance score for each of the extracted trending terms 216. The term importance module 206 generates a list of the extracted trending terms 216 ordered according to respective importance scores. The importance scores are normalized so that the extracted trending terms 216 can be compared and ranked using the importance scores.

The term importance module 206 generates the ranked term lists 212 based on the importance computations of blocks 408, 410. As discussed in reference to those blocks, the term importance module 206 generates an ordered list of the extracted post terms 210 and an ordered list of the extracted trending terms 216—these lists are ordered according to the importance scores and therefore considered ranked. The procedure 400 continues at ‘A’ from FIG. 4A to FIG. 4B.

A list of important terms extracted from the content posted online about the entity is merged with a list of important terms extracted from the relevant items of content about the trending topics (block 412). In accordance with the principles discussed herein, these lists are merged to generate a first combined list of terms. For example, the merge module 208 merges the ranked term lists 212 into a single list. Thus, the single list includes the terms from both the ordered list of the extracted post terms 210 and the ordered list of the extracted trending terms 216. The merge module 208 merges these lists by combining the importance scores computed for the terms, e.g., using a monotonic function ƒ( ).

A second combined list of the merged terms is generated by ordering the terms of the first combined list according to a respective relevance to the entity (block 414). For example, the key term identification module 112 determines a relevance score for each of the terms in the first combined list. The key term identification module 112 then generates a list in which the terms of the first combined list are ordered according to the relevance scores.

Digital content identifying the key terms is generated by combining rankings of the terms in the first and second combined lists and ordering the terms according to the combined rankings (block 416). For example, the merge module 208 combines the ranking of a term in the first combined list (from block 412) with the ranking of the term in the second combined list (from block 414). The merge module 208 combines the rankings in this way for each of the terms in the first and second combined lists. Using the combined rankings, the merge module 208 orders the terms and generates a list in which the terms are ordered accordingly. This list corresponds to the key terms 218. By combining the rankings of the terms from the first and second combined lists, the merge module 208 ensures that the order of the identified key terms 218 reflects both an interest of the community associated with the entity and current trends observed in online content. In other words, the key terms 218 that are more favorably ranked have been determined important both to the community associated with the entity and in current trends observed in online content.

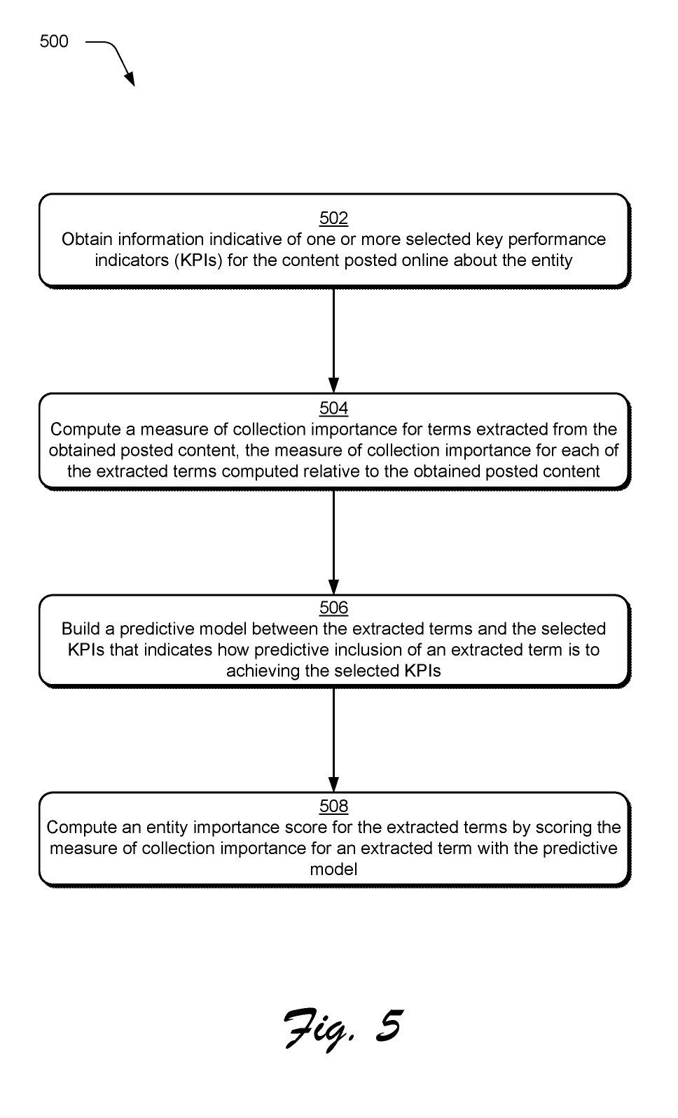

FIG. 5 depicts an example procedure 500 in which an importance to the entity is computed for terms extracted from content posted online about the entity.

Information indicative of one or more selected key performance indicators (KPIs) is obtained for content posted online about an entity (block 502). For example, the key term identification module 112 selects one or more KPIs for use in determining an importance of the extracted post terms 210. As discussed above, KPIs correspond to any of a variety of different trackable actions taken by users relative to posts, such as likes, dislikes, shares, views, an average amount of time viewed, a number of comments, a number of comments expressing positive sentimentality toward a post (or another comment made about the post), a number of comments expressing negative sentimentality toward the post (or another comment made about the post), reposts, hyperlinks that reference the post, an influence of users interacting with the post, and so forth. The key term identification module 112 obtains information regarding the one or more selected KPIs for the collected entity-based posts 108.

A measure of collection importance is computed for terms extracted from the obtained posted content (block 504). In accordance with the principles discussed herein, the collection importance is computed for each of the extracted terms relative to the obtained posted content. Term frequency-inverse document frequency (TFIDF) is a statistic that reflects how important a term is to a document in a collection of documents or corpus, for example. Assuming TFIDF is used as the measure of collection importance, the term importance module 206 computes TFIDF for each of the extracted post terms 210 relative to the collected entity-based posts 108.

A predictive model is built between the extracted terms and the selected KPIs (block 506). In accordance with the principles discussed herein, the predictive model indicates how predictive inclusion of an extracted term is to achieving the selected KPIs. For example, the term importance module 206 builds a predictive model between the extracted post terms 210 and the information obtained about the selected KPIs at block 502. As noted above, the predictive model may be a Random forest model, a neural network, a classification and regression tree (CART), and so forth.

An entity importance score is computed for the extracted terms by scoring the measure of collection importance for a given extracted term with the predictive model (block 508). For example, the term importance module 206 computes an importance score for each of the extracted post terms 210 by scoring, for a given term, the collection importance computed at block 504 with the predictive model built at block 506. These entity importance scores are indicative of importance of the extracted post terms 210 to the entity. Accordingly, it may correspond to the importance computed at block 408 of FIG. 4A.

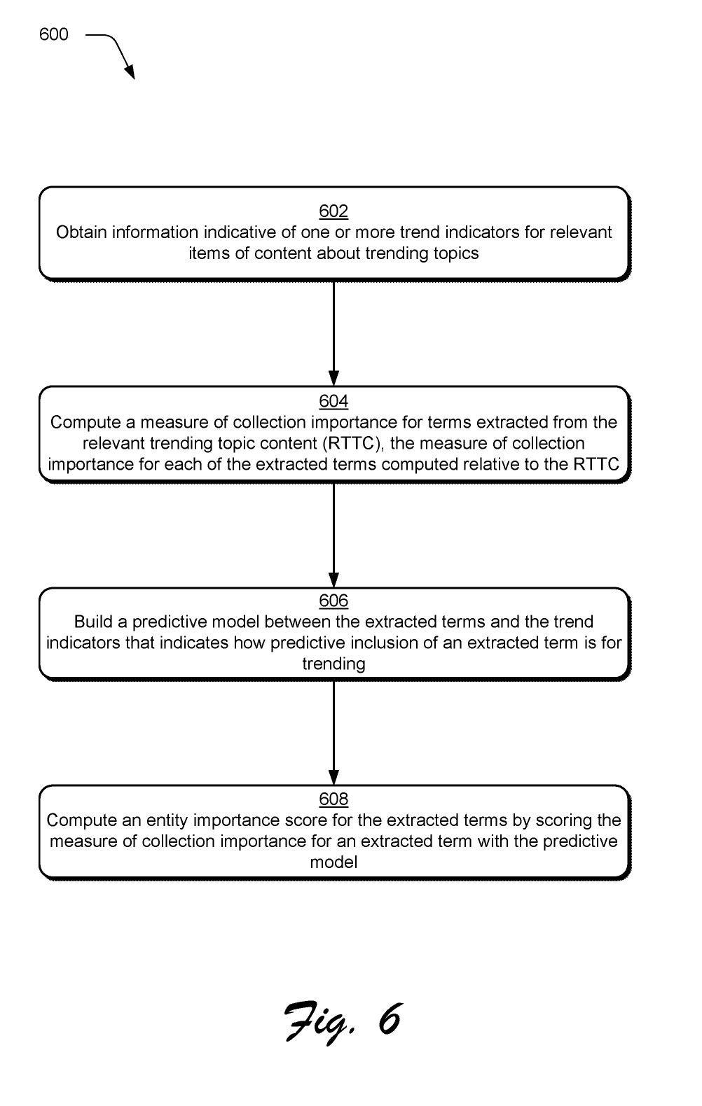

FIG. 6 depicts an example procedure 600 in which an importance to the entity is computed for terms extracted from content about trending topics relevant to the entity.

Information indicative of one or more trend indicators is obtained for relevant items of content about trending topics (block 602). As discussed above, trend indicators may correspond to any of a variety of metrics that indicate a trendiness of content, such as clicks on the content, views of content, shares of content, and so forth. The key term identification module 112 obtains information regarding trend indicators for the collected trending-topic content 110, e.g., via metadata of the collected trending-topic content 110 that describes the trend indicators.

A measure of collection importance is computed for terms extracted from the relevant trending topic content (block 604). In accordance with the principles discussed herein, the collection importance is computed for each of the extracted terms relative to the obtained trending topic content. Assuming that TFIDF is again used as the measure of collection importance, the term importance module 206 computes TFIDF for each of the extracted trending terms 216 relative to the collected trending-topic content 110.

A predictive model is built between the extracted terms and the trend indicators (block 606). In accordance with the principles discussed herein, the predictive model indicates how predictive inclusion of an extracted term is for trending. For example, the term importance module 206 builds a predictive model between the extracted trending terms 216 and the information obtained about trend indicators at block 602.

An entity importance score is computed for the extracted terms by scoring the measure of collection importance for a given extracted term with the predictive model (block 608). For example, the term importance module 206 computes an importance score for each of the extracted trending terms 216 by scoring, for a given trending term, the collection importance computed at block 604 with the predictive model built at block 606. These entity importance scores are indicative of importance of the extracted trending terms 216 to the entity. Accordingly, it may correspond to the importance computed at block 410 of FIG. 4A.

Having described example procedures in accordance with one or more implementations, consider now an example system and device that can be utilized to implement the various techniques described herein.

### Example System and Device

FIG. 7 illustrates an example system generally at 700 that includes an example computing device 702 that is representative of one or more computing systems and/or devices that implement the various techniques described herein. This is illustrated through inclusion of the key term identification module 112, which operates as described above. The computing device 702 may be, for example, a server of a service provider, a device associated with a client (e.g., a client device), an on-chip system, and/or any other suitable computing device or computing system.

The example computing device 702 includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An embodiment of the described modules and techniques may be stored on or transmitted across some form of computer-readable media. The computer-readable media may include a variety of media that may be accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 702, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules are implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software are achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributed throughout the system 700. For example, the functionality is implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to identify key terms related to an entity, a method implemented by a computing device, the method comprising:
obtaining, by the computing device, trending topic content and posts about an entity;
determining, by the computing device, which of the trending topic content is relevant to the entity based on a similarity of the trending topic content to a group of representative terms associated with the entity;
extracting, by the computing device, terms from the posts and terms from the relevant trending topic content, the terms extracted having at least one predefined type;
computing, by the computing device, a first set of importance scores for the terms from the posts based on a first predictive model built using the terms from the posts and at least one key performance indicator (KPI) that indicates performance of the posts in achieving an action as described by information associated with the posts;
computing, by the computing device, a second set of importance scores for the terms from the relevant trending topic content based on a second predictive model built using the terms from the relevant trending topic content and at least one trend indicator that measures a trend amount;
merging, by the computing device, a list of the terms from the posts with a list of the terms from the relevant trending topic content based at least in part on the first and second sets of importance scores; and
generating, by the computing device, digital content identifying the key terms related to the entity from the merged lists of the terms from the posts and the relevant trending topic content.

2. A method as described in claim 1, further comprising:
generating a first combined list by said merging the lists of the terms from the posts and the relevant trending topic content, and wherein generating the digital content identifying the key terms related to the entity includes:
computing relevance scores for the terms from the posts and the relevant trending topic content of the first combined list, a relevance score indicating a relevance of a given term to the entity; and
generating a second combined list having the terms from the posts and the relevant trending topic content ranked according to the relevance scores.

3. A method as described in claim 2, further comprising:
ranking the terms from the posts and the relevant trending topic content of the first combined list based on the first and second sets of importance scores, and wherein generating the digital content identifying the key terms related to the entity further includes:
computing combined rankings for the terms from the posts and the relevant trending topic content, said computing the combined rankings including combining a rank in the first combined list with a rank in the second combined list; and
ordering the terms from the posts and the relevant trending topic content according to the combined rankings to identify the key terms.

4. A method as described in claim 3, further comprising using rank aggregation to combine the rank in the first combined list with the rank in the second combined list.

5. A method as described in claim 3, further comprising presenting the key terms ordered according to the combined rankings.

6. A method as described in claim 1, wherein determining which of the trending topic content is relevant to the entity includes:
identifying the group of representative terms;
computing the similarity as an aggregated relevance for each item of the trending topic content with respect to the representative terms; and
scoring the items of the trending tropic content based on the aggregated relevance effective to indicate relevance to the entity.

7. A method as described in claim 6, wherein identifying the group of representative terms includes semantically querying a known resource for relationships to and properties associated with the entity in the known resource.

8. A method as described in claim 1, wherein the posts about the entity are obtained from social networking services.

9. A method as described in claim 1, wherein the trending topic content is obtained from a service that tracks trending topics and maintains a repository of representative content for the trending topics.

10. A method as described in claim 1, wherein the predefined type of terms includes any of named entities, noun phrases, bigrams, or trigrams.

11. A method as described in claim 1, further comprising receiving an indication via user input of one or more keywords that relate to the entity, the keywords being used to obtain the posts about the entity and determine which of the trending topic content is relevant to the entity.

12. A method as described in claim 1, further comprising presenting an arrangement of the key terms, said arrangement visually indicating a respective importance to the entity based at least in part on the respective said importance scores.

13. In a digital medium environment to identify key terms related to an entity, a method implemented by a computing device, the method comprising:
obtaining, by the computing device, at least one key performance indicator (KPI) from information associated with posts about an entity, the at least one KPI indicating performance in achieving an action for the posts;
obtaining, by the computing device, at least one trend indicator from information associated with trending topic content determined relevant to the entity, the at least one trend indicator measuring a trend amount for the trending topic content;
generating, by the computing device, a first predictive model between terms extracted from the posts and the at least one KPI as an output vector of the first predictive model, the output vector of the first predictive model indicating how predictive inclusion of the terms extracted from the posts is of achieving the action, said generating the first predictive model including computing importance scores for the terms extracted from the posts based on the output vector of the first predictive model;
generating, by the computing device, a second predictive model between terms extracted from the relevant trending topic content and the at least one trend indicator as an output vector of the second predictive model, the output vector of the second predictive model indicating how predictive inclusion of the terms extracted from the relevant trending topic content is of achieving a particular trend amount indicating the relevant trending topic content is trending, said generating the second predictive model including computing importance scores for the terms extracted from the relevant trending topic content based on the output vector of the second predictive model;
generating, by the computing device, digital content identifying the key terms related to the entity based on the importance scores for the terms extracted from the posts and the terms extracted from the relevant trending topic content.

14. A method as described in claim 13, wherein computing the importance scores for the terms extracted from the posts includes computing a measure of collection importance for each of the terms extracted from the posts, said measure of collection importance indicative of an importance of a given term within the posts about the entity.

15. A method as described in claim 14, wherein said computing the importance scores for the terms extracted from the posts comprises utilizing the first predictive model to generate a score based on the measure of collection importance for each of the terms extracted from the posts.

16. A method as described in claim 13, wherein computing the importance scores for the terms extracted from the relevant trending topic content includes computing a measure of collection importance for each of the terms extracted from the relevant trending topic content, said measure of collection importance indicative of an importance of a given term within the relevant trending topic content.

17. A method as described in claim 16, wherein said computing the importance scores for the terms extracted from the relevant trending topic comprises utilizing the second predictive model to generate a score based on the measure of collection importance for each of the terms extracted from the relevant trending topic.

18. A method as described in claim 13, wherein generating the digital content comprises arranging the key terms for presentation to a user in an arrangement configured to visually indicate a respective importance of the key terms to the entity according to the importance scores.

19. A system implemented in a digital medium environment to identify key terms related to an entity, the system comprising:
at least one processor; and
memory having stored thereon computer-readable instructions that are executable by the at least one processor to perform operations comprising:
receiving an indication of the entity via a user interface;
collecting posts about the entity from one or more social networking services, and trending topic content from a repository that tracks trending topics;
computing a first set of importance scores for terms extracted from the posts and a second set of importance scores for terms extracted from the trending topic content relevant to the entity based on a first and a second predictive model, respectively, wherein:
the first predictive model is built using the terms extracted from the posts and at least one key performance indicator (KPI) that indicates performance of the posts in achieving an action as described by information associated with the posts; and
the second predictive model is built using the terms extracted from the relevant trending topic content and at least one trend indicator that measures a trend amount; and
generating digital content identifying the key terms based on the first and second sets of importance scores.

20. A system as described in claim 19, wherein the operations further comprise:
determining relevance scores indicative of relevance of the key terms to the entity; and
ranking the key terms based on a combination of the first and second sets of importance scores and the respective said relevance scores to identify the key terms.
